(19) United States
(12) Patent Application Publication
(10) Pub. No.: US 2024/0242956 A1
(43) Pub. Date: Jul. 18, 2024

(54) TAYLOR CONE EMITTER DEVICES AND TAYLOR CONE ANALYSIS SYSTEMS

(71) Applicant: RESTEK CORPORATION, Bellefonte, PA (US)

(72) Inventors: German A. Gomez-Rios, San Jose, CA (US); Thomas E. KANE, Bellefonte, PA (US)

(21) Appl. No.: 18/562,077

(22) PCT Filed: May 26, 2022
(86) PCT No.: PCT/US2022/031084

§ 371 Date: Nov. 17, 2023

Related U.S. Application Data
(60) Provisional application No. 63/194,353, filed on May 28, 2021.

(51) Int. Cl. H01J 49/16

(52) U.S. Cl. CPC H01J 49/167

(57) ABSTRACT

A Taylor cone emitter device is disclosed, including a substrate, a sorbent layer on at least a portion of the substrate, a Taylor cone emitter portion extending from the substrate, and a reservoir surface configured to retain a liquid and feed the liquid to the Taylor cone emitter portion while a Taylor cone is emitted from the Taylor cone emitter portion. The Taylor cone emitter portion is free of sharp features having an edge or point with a radius of curvature of less than 250 μm and includes a broadly curved surface having a radius of curvature of at least 300 μm from which the Taylor cone emanates. A Taylor cone analysis system is disclosed, including an analytical instrument having a sample inlet, the Taylor cone emitter device, and at least one electric field lens configured to tune Taylor cone generation from the Taylor cone emitter portion.

### RELATED APPLICATIONS

This application claims the benefit of and priority to U.S. Provisional Patent Application No. 63/194,353, filed May 28, 2021, entitled “Improvements to Substrate Electrospray Emitters,” which is hereby incorporated by reference in its entirety.

### FIELD OF THE INVENTION

This application is directed to Taylor cone emitter devices and Taylor cone analysis systems. In particular, this application is directed to Taylor cone emitter devices and Taylor cone analysis systems having Taylor cone emitter portions free of sharp features.

### BACKGROUND OF THE INVENTION

### Taylor Cone Emitter Devices

Taylor cone emitter devices are devices capable of creating a Taylor cone in the presence of a liquid and under the influence of an electric field. The Taylor cone may contain the chemical analyte species of interest. Known Taylor cone emitter devices include coated electrospray needles, coated blade spray devices (described below), sorbent coated electrodes, SPME tips, and porous formed probes, among others. Taylor cone emitters include at least one material capable of generating an electric field. In some cases, a liquid applied to the Taylor cone emitter serves as the layer generating the electric field.

“Electrical surface charges” are charges generated on a surface when a voltage is applied to the emitter or conductor. Surface charge concentrates at regions with the highest curvature. Therefore, sharp edges or pointed tips are used to increase the local charge density. The electric field on the surface (which may be metallic, polymeric, or other) results from the surface charge and is perpendicular to the surface, and its strength is proportional to the surface charge density. The electric field gradient is the rate at which the electric field falls off, and it is strongest on such edges and lines and points. Regions of high electric field gradient are most likely to generate Taylor cones from applied solvent.

Typically, the Taylor cone is localized in a specific region of the emitter where the cone released from the emitter is positioned to facilitate collection of ionized molecules generated from the cone into a mass spectrometer or other ionized particle analyzer. To localize Taylor cones, the emitter device shapes typically include regions having a small radius of curvature, such as sharp points or edges. Localized electric fields are also achieved with protrusions having thin cross sections, narrow diameters, or high aspect ratios as in the case of rods or cones. The degree of sharpness at an edge or point of a surface may be quantified as the radius of curvature of the edge or point. Commercial Taylor cone emitter devices are manufactured from stainless steel, with a nominal thickness of 0.015 inches (381 μm), although thinner and thicker embodiments may also be used. Commercially available Taylor cone emitter devices have radii of curvature of 10-150 μm. Post processing steps may be employed to decrease the radius of curvature. Follow-on grinding or polishing may create a “razor-sharp” edge. These degrees of sharpness have been measured to have a radius of curvature as low as 2 μm.

Taylor cone emitters may be produced from a single material (substrate) or more than one material in the form of layers or coatings where at least a portion of the uppermost surface serves to collect and release analyte compounds.

Suitable analyte collection materials may collect chemical analytes from a bulk sample. The collection mechanism may be adsorption, dissolution, absorption, or specific binding (e.g., antigen-antibody binding, pore shape and size selection such as metal organic frameworks).

The native uppermost surface of the emitter may serve as an analyte collection material, or analyte collection material may be applied to the uppermost surface. Known applied materials include sorbent beds created with particles and irregular or conformal contiguous coatings. The analyte collection material may be porous or nonporous. The collection material may be permeable or nonpermeable. Typically, the collection material is chemically compatible with the sample and the solvent employed to product the Taylor cone.

The analyte collection material may be first separately dispersed in a gas or liquid sample where analyte collection occurs, followed by the attachment of the analyte containing collection material onto the emitter, including, but not limited to, magnetic particles chemically modified to collect analytes, which are then adhered onto the emitter surface with an applied electric or magnetic field.

Preferably, the sample only comes into physical contact with the analyte collection material. In cases where the analyte collection material is porous or incompletely covers the uppermost surface of the emitter, the uppermost surface of the emitter preferably does not interact with analytes of interest. In cases where the uppermost surface of the emitter is not also the analyte collection material, a protective coating or primer layer is applied between the substrate uppermost surface and the analyte collecting material. This protective coating may be polymeric or a direct chemical passivation of the emitter surface.

### Coated Blade Devices

Coated Blade Spray (“CBS”) is a solid phase microextraction (“SPME”)-based analytical technology previously described in the literature (Pawliszyn et al.; U.S. Pat. No. 9,733,234) that facilitates collection of analytes of interest from a sample and the subsequent direct interface to mass spectrometry systems via a substrate spray event (i.e., electrospray ionization). Solid phase microextraction devices are a form of Taylor cone emitter device typically characterized by having a substrate suitable for retaining a sample. CBS devices typically have regions having a small radius of curvature, such as sharp points or edges.

“Coated blade spray,” “CBS blade.” and “blade device” are used synonymously herein. CBS blades may include, but are not limited to, magnetic CBS blades and immunoaffinity blades.

There are two basic stages to CBS-based chemical analysis: (1) analyte collection followed by (2) instrumental analysis. Analyte collection is performed by immersing the sorbent-coated end of the blade device directly into the sample. For liquid samples, the extraction step is generally performed with the sample contained in a vial or well plate.

After analyte collection, the blade device is removed from the sample, and, following a series of rinsing steps, the blade device is then presented to the inlet of the mass spectrometer (“MS”) for analysis. In this fashion, the blade device undergoes several transfer steps. Reliable positioning of the blade device for each of these steps is therefore important, both for manual and robotic automation handling circumstances.

As a direct-to-MS chemical analysis device, the blade device requires a pre-wetting of the extraction material so as to release the collected analytes and facilitate the electrospray ionization process (formation of a Taylor cone). Subsequently, a differential potential is applied between the non-coated area of the substrate and the inlet of the MS system, generating an electrospray at the tip of the CBS device. The electric field between the blade and the MS system must be reproducibly created in order to ensure reliable run-to-run precision. Proper positioning of the blade device with respect to the MS inlet is therefore very important, including the radial (or rotational) orientation of the blade device.

### MS Analysis

In recent years, several new direct-to-MS technologies have been developed aiming to shorten analysis turnaround time (“TAT”), which, in the case of clinical analysis, is the time it takes from the reception of the sample by the analyst to the delivery of the analytical result to the physician. Among this new set of technologies, MS technologies without the use of a chromatographic separation step and a sample preparation step have proven to be the most successful in TAT reduction. However, most of these technologies are limited with respect to quantitation and robustness of the instrumentation over time. One approach taken, aiming to improve sensitivity at the expense of time, is the use of simple sample preparation approaches prior to the direct interface with mass spectrometry. Among the sample preparation tactics explored so far, those that can be easily miniaturized have been the most efficient. Analyte collection/extraction may be performed either onto a liquid phase extracting material (e.g., an organic solvent) or onto a solid phase extracting material (e.g., a polymeric material). In the case of extracting materials in solid phase, micro-solid phase extraction (“μSPE”), disperse solid phase extraction (“dSPE”), magnetic solid phase extraction (“mSPE”), open bed SPE (“oSPE”), solid phase microextraction (“SPME”) and magnetic SPME (“mSPME”) have been most commonly used strategies. There is not always a clear technical differentiation between oSPE and SPME methods, or between magnetic mSPME and mSPE methods. Herein, SPME, uSPE, mSPME, and mSPE are therefore used synonymously.

SPME directly interfaced with mass spectrometry instrumentation has surged as means to improve the performance of either existing direct to MS technologies or SPME methods directly hyphened with MS via chromatographic separations. When compared to chromatographically based methods, direct-to-MS couplings typically focused on improving at least one of turnaround time, sensitivity, simplicity, or cost-per-sample.

SPME-MS developments may be classified based on either the analyte ionization mechanism (e.g., electrospray ionization (“ESI”)), the analyte desorption/elution mechanism (i.e., liquid-, thermal- or laser-based methods), the material used to manufacture the sampling device and/or the extracting phase, the application where the microextraction devices have been implemented. ESI is a technique traditionally used in combination with liquid chromatography (“LC”) to generate ions for MS. Conventionally, a liquid carrying the analytes of interest is pumped to the ionization source (e.g., a stainless steel capillary) where an aerosol spray is formed by the application of an excitation voltage differential potential between a stainless steel capillary and the mass spectrometer inlet. In most cases, the excitation voltage comprises a few thousands of volts. With aid of nebulizing gas, solvent droplets from the spray undergo rapid solvent evaporation prior to the inlet of the mass spectrometer, releasing ions to the gas phase for analysis in the mass spectrometer. Most ESI sources commercially available also use heat to increase the efficiency of desolvation. The sensitivity of ESI-MS is determined by the efficiency of producing gas-phase ions from analyte molecules in charged droplets (ionization efficiency) and the effective transfer of the charged species from the atmospheric pressure ion source to the high-vacuum MS analyzer (ion transmission efficiency). Nano-electrospray ionization (nano-ESI) is widely recognized as the most efficient method of introducing a liquid sample for direct analysis by mass spectrometry. The technique is distinguished from more conventional forms of electrospray by the fashion in which it is carried out. One to two microliters of sample are deposited into a glass or quartz tube that has a tip diameter in the order of 1 μm and is sprayed from the tip by applying a voltage to the solution. The actual flow rate is usually a few nL/min to a few tens of nL/min, controlled by the diameter of the tip, the voltage applied, and the backpressure that is sometimes applied to the tube content. Nano-ESI reduces interference effects from salts and other species and provides better sensitivity toward a variety of analytes, including peptides and oligosaccharides, in samples contaminated by high levels of salts. Ionization efficiency is attributed to the reduced droplet size compared with electrospray at higher flow rates.

Substrate spray ionization is a type of ESI where ions are generated from a solid substrate, such as a leaf or a piece of paper, by applying a high electrical differential potential between said substrate and the mass spectrometer inlet on a sufficiently wet substrate so to generate a Taylor cone. In the case of non-conductive substrates, the potential is directly applied to the solvent. Most of the substrate ESI devices developed to date, where no sample preparation steps are intrinsic of the analytical workflow, have been categorized as ambient ionization technologies (e.g., paper spray ionization). In line with its name, most substrate spray ionization devices reported to date generate an ESI on a fully open environment.

Unlike traditional ESI, the liquid used for electrospray ionization in Taylor cone emitters devices is neither contained on a capillary nor pressurized throughout the capillary. Indeed, the flow of liquid towards the tip of a Taylor cone emitter during the electrospray process predominately relies on gravitational forces (if applied) and the electro-osmotic flow created when applying a potential difference between the tip of the Taylor cone emitter and the inlet of the mass spectrometer (as long as the tip of the Taylor cone emitter is sufficiently wet). As a result, said flow of liquid and the electrospray ionization process itself are more susceptible to the environmental conditions surrounding it.

### BRIEF DESCRIPTION OF THE INVENTION

In one exemplary embodiment, a Taylor cone emitter device includes a substrate, a sorbent layer disposed on at least a portion of the substrate, a reservoir surface configured to retain a liquid, and a Taylor cone emitter portion extending from the substrate. The reservoir surface is configured to feed the liquid to the Taylor cone emitter portion while a Taylor cone is emitted from the Taylor cone emitter portion. The Taylor cone emitter portion is free of sharp features having an edge or point with a radius of curvature of less than 250 μm. The Taylor cone emitter portion includes a broadly curved surface having a radius of curvature of at least 300 μm from which the Taylor cone emanates.

In another exemplary embodiment, a Taylor cone analysis system includes an analytical instrument having a sample inlet, at least one electric field lens, and a Taylor cone emitter device. The Taylor cone emitter device includes a substrate, a sorbent layer disposed on at least a portion of the substrate, a reservoir surface configured to retain a liquid, and a Taylor cone emitter portion extending from the substrate. The reservoir surface is configured to feed the liquid to the Taylor cone emitter portion while a Taylor cone is emitted from the Taylor cone emitter portion. The Taylor cone emitter portion is free of sharp features having an edge or point with a radius of curvature of less than 250 μm. The Taylor cone emitter portion includes a broadly curved surface having a radius of curvature of at least 300 μm from which the Taylor cone emanates. The at least one electric field lens is configured to tune Taylor cone generation from the Taylor cone emitter portion.

### BRIEF DESCRIPTION OF THE DRAWINGS

FIGS. 1(a)-(b) illustrate a commercial Taylor cone emitter device from a plan view (FIG. 1(a)) and a perspective view (FIG. 1(b)).

FIGS. 2(a)-(b) illustrate the radii of curvature of edges (FIG. 2(a), taken along 2a-2a) and a point (FIG. 2(b), taken along 2b-2b) of a commercial Taylor cone emitter device.

FIG. 3 is a plan view illustrating a commercial Taylor cone emitter device positioned relative to a sample inlet of an analytical instrument.

FIGS. 4(a)-(b) illustrate a Taylor cone emitter device free of sharp features from a perspective view (FIG. 4(a)) and a cross-sectional view along 4b-4b (FIG. 4(b)), according to an embodiment of the present disclosure.

FIGS. 5(a)-(e) illustrate a Taylor cone emitter device free of sharp features and with a rounded rectangular cuboid portion having a stadium cross-section from a plan view (FIG. 5(a)), a cross-section view along 5b-5b (FIG. 5(b)), a perspective view (FIG. 5(c)), and a plan view with a sorbent layer (FIG. 5(d)), according to an embodiment of the present disclosure.

FIGS. 6(a)-(b) illustrates a Taylor cone emitter device free of sharp features and with a rounded rectangular cuboid portion having a rounded rectangular cross-section from a perspective view (FIG. 6(a)) and a cross-section view along 6b-6b (FIG. 6(b)), according to an embodiment of the present disclosure.

FIGS. 7(a)-(e) illustrate a Taylor cone emitter device free of sharp features and with a spheroid portion from a plan view (FIG. 7(a)), a cross-section view along 7b-7b (FIG. 7(b)), a cross-section view along 7c-7c (FIG. 7(c)), a perspective view (FIG. 7(d)), and a plan view with a sorbent layer (FIG. 7(e)), according to an embodiment of the present disclosure.

FIGS. 8(a)-(d) illustrate a Taylor cone emitter device free of sharp features and with a hemispheroid portion from a plan view (FIG. 8(a)), a cross-sectional view along 8b-8b (FIG. 8(b)), a perspective view (FIG. 8(c)), and a plan view with a sorbent layer (FIG. 8(d)), according to an embodiment of the present disclosure.

FIGS. 9(a)-(e) illustrate a Taylor cone emitter device free of sharp features and with a rounded discoid portion from a plan view (FIG. 9(a)), a cross-section view along 9b-9b (FIG. 9(b)), a cross-sectional view along 9c-9c (FIG. 9(c)), a perspective view (FIG. 9(d)), and a plan view with a sorbent layer (FIG. 9(e)), according to an embodiment of the present disclosure.

FIGS. 10(a)-(c) illustrate a Taylor cone emitter devices free of sharp features and with a terminal flow-disrupting feature (FIG. 10(a)), an intermediate flow-disrupting feature (FIG. 10(b)), and a plurality of terminal flow-disrupting features (FIG. 10(c)), according to an embodiment of the present disclosure.

FIGS. 11(a)-(c) illustrate a Taylor cone emitter device free of sharp features and with at least one liquid-channeling groove (FIG. 11(a)) with alternative cross-sections showing one groove (FIG. 11(b) taken along 11b-11b or two grooves (FIG. 11(c)) taken along 11c-11c, according to an embodiment of the present disclosure.

FIGS. 12(a)-(d) illustrate a Taylor cone emitter device free of sharp features and broadly curved in two dimensions from a plan view (FIG. 12(a)), a cross-sectional view along 12b-12b (FIG. 12(b)), a cross-sectional view along 12c-12c (FIG. 12(c)), and a perspective view (FIG. 12(d)), according to an embodiment of the present disclosure.

FIGS. 13(a)-(c) are plan views illustrating a Taylor cone analysis system with an analytical instrument, an electric field lens, and a Taylor cone emitter device, with the at least one electric field lens being disposed between the Taylor cone emitter portion and the sample inlet (FIG. 13(a)), at an equal distance from the sample inlet (FIG. 13(b)), and or at a greater distance from the sample inlet (FIG. 13(c)), according to embodiments of the present disclosure.

FIG. 14 is a plan view illustrating a Taylor cone analysis system with an analytical instrument, a plurality of electric field lenses, and a Taylor cone emitter device, according to an embodiment of the present disclosure.

FIGS. 15(a)-(c) illustrate a Taylor cone analysis system with an analytical instrument and a Taylor cone emitter device at different orientations relative to the sample inlet including a normal angle (FIG. 15(a)), an oblique angle (FIG. 15(b)), and a perpendicular angle (FIG. 15(c)), according to an embodiment of the present disclosure.

FIG. 16 is a plan view illustrating a laboratory-built Taylor cone analysis system, according to an embodiment of the present disclosure.

Wherever possible, the same reference numbers will be used throughout the drawings to represent the same parts.

### DETAILED DESCRIPTION OF THE INVENTION

In comparison to devices and systems lacking at least one of the features described herein, the devices and systems of the present embodiments increase flexibility of Taylor cone emitter device positioning and orientation during Taylor cone formation, decrease voltage requirements to form a Taylor cone, increase portability, decrease injury likelihood, increase safety, localize and increase control over Taylor cone emission point, increase flexibility of Taylor cone emitter device shape and size, promote usage of a finite elution solvent volume, promote usage of voltage applied to a lens to terminate a Taylor cone, increase synchronization, eliminates need for a high voltage relay, decreases or prevents electromagnetic inference pulse, decouples Taylor cone production from high voltage pulse rise time, or combinations thereof.

As used herein, “about” indicates a variance of ±20% of the value being modified by “about,” unless otherwise indicated to the contrary.

As used herein, “Taylor cone emitter” includes, but is not limited to, an article capable of forming a Taylor cone, including, but not limited to, a solid phase microextraction device or a CBS device. A solid phase microextraction device is a form of a Taylor cone emitter device, but not all Taylor cone emitter devices are solid phase microextraction devices.

“Analytes of interest” should be understood as any analyte collected on or extracted by the Taylor cone emitter device. In some examples, the analytes of interest are not targeted (i.e., are not explicitly monitored during the selection/detection steps in the mass spectrometer analyzer). “Analyte of interest,” “target analyte” (“TA”) and “compound of interest” should be understood to be synonymous. In some embodiments, a compound of interest may be a “chemical of interest” or a “molecule of interest” or a “molecular tag.”

The expressions “analyte collection,” “analyte extraction,” “analyte enrichment,” and “analyte loading” are intended to be understood as synonymous terms.

The terms “extractive material,” “sorbent,” “adsorbent,” “absorbent,” “polymeric phase,” “polymer sorbent,” “magnetic particles,” “coated magnetic particles,” and “functionalized magnetic particles” are intended to refer materials use to collect the analytes of interest.

Suitable analyte collection materials may collect chemical analytes from a bulk sample. The collection mechanism may be adsorption, dissolution, absorption, specific binding (e.g., antigen-antibody binding, pore shape and size selection such as metal organic frameworks), or combinations thereof.

As used herein, “solid phase microextraction” includes, but is not limited to, a solid substrate coated with a polymeric sorbent coating, wherein the coating may include metallic particles, silica-based particles, metal-polymeric particles, polymeric particles, or combinations thereof which are physically or chemically attached to the substrate. In some non-limiting examples, the solid substrate has at least one depression disposed in or protrusion disposed on a surface of the substrate and said substrate includes at least one polymeric sorbent coating disposed in or on the at least one depression or protrusion. The term “solid phase microextraction” further includes a solid substrate with at least one indentation or protrusion that contains at least one magnetic component for the collection of magnetic particles or magnetic molecules onto the solid substrate.

A native uppermost surface of a Taylor cone emitter may serve as an analyte collection material, or analyte collection material may be applied to the uppermost surface. Examples of applied materials may include sorbent beds created with particles, and irregular or conformal contiguous coatings. The analyte collection material may be porous or nonporous. The collection material may be permeable or nonpermeable.

The term “analyte injection” should be understood as the act of injecting an ion beam onto a mass spectrometer inlet. “Analyte injection” should be understood as a synonym of “electrospray ionization,” “ion ejection,” “ion expelling,” and “analyte spray.”

The terms “skimmer cone” and “curtain plate” are used synonymously.

The terms “mass spectrometer inlet,” “inlet,” “skimmer cone,” “MS injection aperture,” and “mass spectrometer front-end” are used herein synonymously.

As used herein, “sharp” or “sharply” indicate a radius of curvature of less than 250 μm.

As used herein, “broad” or “broadly” indicate a radius of curvature of at least 300 μm.

The Taylor cone emitter may be any suitable material, including, but not limited to, a metal, a metal alloy, a glass, a fabric, a polymer, a polymer metal oxide, or combinations thereof. The substrate may include, by way of non-limiting example, nickel, nitinol, titanium, aluminum, brass, copper, stainless steel, bronze, iron, or combinations thereof. Similarly, the substrate may include any material used for additive manufacturing. 3D printing, lithography, or circuit manufacturing, such as, but not limited to, silicon wafer, glass fiber reinforced polymer (“fiberglass”), polytetrafhioroethylene, polystyrene, conductive polystyrene, polyimide film, polycarbonate-acrylonitrile butadiene styrene (“PC-ABS”), polybutylene terephthalate (“PBT”), polylactic acid, poly(methyl methacrylate), polycarbonate (“PC”), acrylonitrile butadiene styrene (“ABS”), polyetherimide (e.g., ULTEM), polyphenylsulfone (“PPSF”), polycarbonate-ISO (“PC-ISO”), or combinations thereof.

The phrase “excitation voltage” should be understood as the voltage necessary to expel and generate, via electrospray ionization mechanisms or atmospheric pressure chemical ionization mechanisms, a stable beam of ions from the substrate electrospray emitter. Excitation voltage may range from a few volts to hundreds or even thousands of volts depending on multiple variables including Taylor cone emitter composition, location of the Taylor cone emitter on regards to the mass spectrometer inlet and the characteristics of the environment at which the electrospray is generated. The excitation voltage ranges between 0.1V and 8,000 V, alternatively between 1,500 and 5,500 V, alternatively between 2,000 and 4,000 V. The excitation voltage may be delivered by different sources such as an alternative current supply, direct current supply, or combinations thereof. The excitation voltage supply may be constant, pulsed, modulated, or follow any other voltage function. An excitation stage may include applying an excitation voltage to a Taylor cone emitter for a fixed period.

In some examples, the application of the excitation voltage is short enough so to be considered a pulse (<1 s). In other examples, the signal recorded in the mass spectrometer is attained by applying multiple pulses. In particular examples, the pulse may be either rectangular, triangular, saw-tooth, sinusoidal, or combinations thereof. In particular examples, the voltage may be ramped from a lower voltage up to the excitation voltage. In other examples, the voltage may be ramped from a higher than optimal to the excitation voltage. In additional examples, the excitation stage may comprise multiple combinations of ramping up to and down from the excitation voltage. Excitation voltage may be deprived at any point either electronically, or mechanically, or electromechanically. In preferred examples, the excitation voltage is deprived electromechanically, such as high voltage relay.

Solvent delivery systems may be discrete or continuous. Examples of solvent delivery system include, but are not limited to, a syringe pump, a peristaltic pump, a liquid chromatography pump, a micro droplet solvent dispensing system, an acoustic droplet delivery system, or combinations thereof. An elution solvent delivery system may dispense one or more doses of solvent onto one or more locations of the Taylor cone emitter whereas said doses may be dispensed either discretely or continuously.

The term “solvent aerosol sprayer” should be understood as a synonym of “solvent blaster,” “solvent cloud,” “inlet cleaning system,” “droplet sprayer,” “mist sprayer,” and “venturi sprayer.”

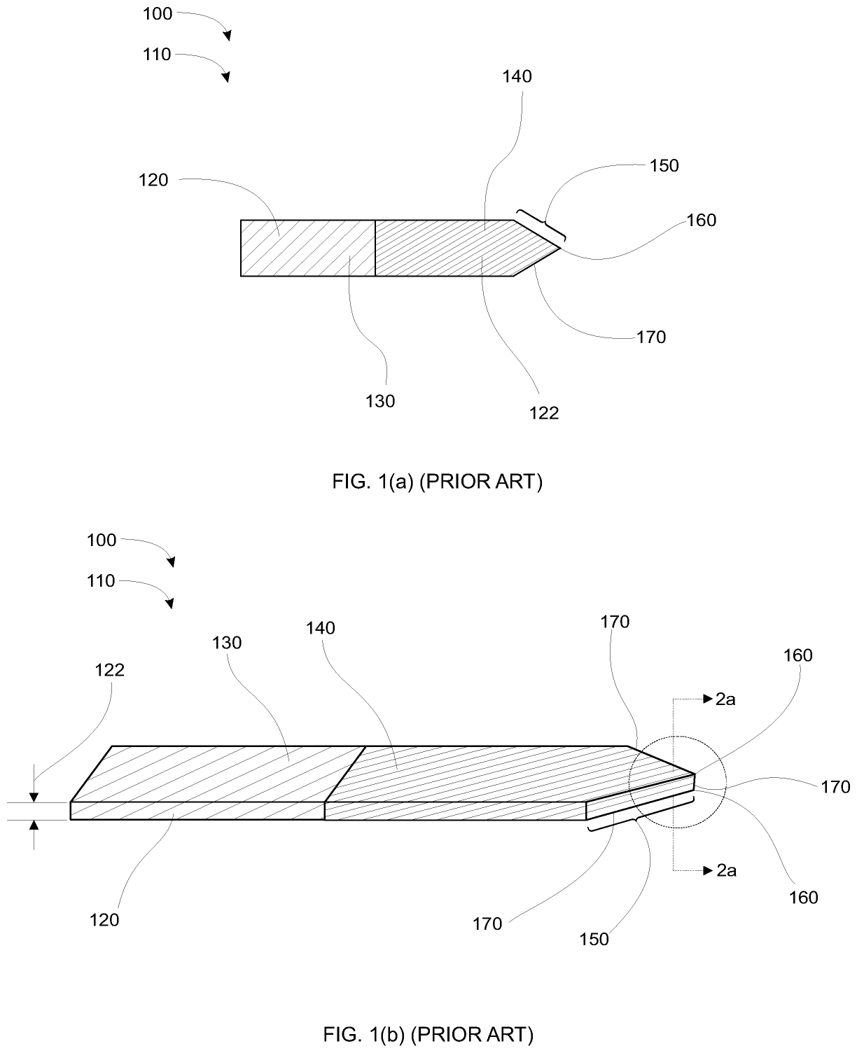

Referring to FIGS. 1(a)-(b), Taylor cone emitter devices 100 have been described as blades, swords, forks and other metaphors that are capable of piercing a sample or a handler, including the CBS device 110 shown. The Taylor cone emitter device 100 includes a substrate 120 having a thickness 122, at least one planar surface 130, a sorbent layer 140 disposed on at least a portion of the at least one planar surface 130, and a tapering tip 150 ending in a sharp point 160 with sharp bevel edges 170 extending from the substrate 120. The substrate 120 may have any suitable dimensions, including, but not limited to, about 4 mm wide by about 40 mm long by about 0.5 mm thick. The substrate 120 may be made from any suitable material, including, but not limited to, conductive materials such as, but not limited to, stainless steels. The sorbent layer 140 may include an extraction phase sorbent including, but not limited to, polymeric particles (e.g., silica modified with C18 groups) and a binder (e.g., polyacrylonitrile). Secondary processes may also be employed to further sharpen the sharp features. The desire for obtaining a sharp, point-like feature is to promote a high electric field gradient in a localized region, in an effort to localize the production of the Taylor cone. This also presents an inherent safety concern to the operator, particularly if the blade device is employed with samples having biohazard or other chemical species which may expose the operator to undue danger during handing. Sharp devices may cut or lacerate the operator's hands or fingers, which is an undesirable quality of the device.

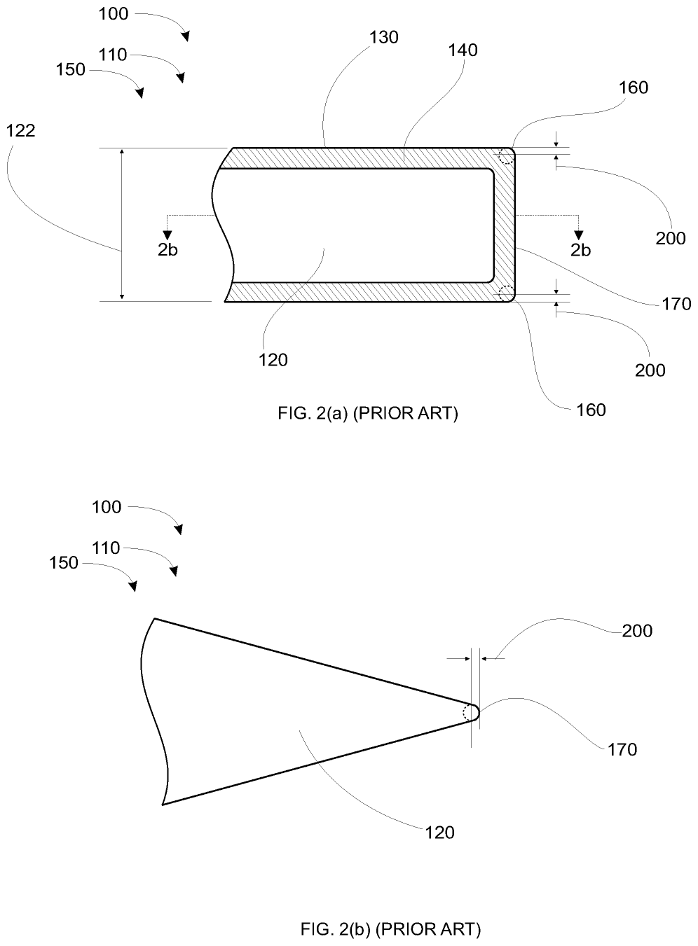

Referring to FIGS. 2(a) and 2(b), expanded views of the sharp bevel edges 170 (FIG. 2(a) and the sharp point (FIG. 2(b)) are shown.

The sharp features have a radius of curvature 200 less that 250 μm, alternatively less than 200 μm, alternatively less than 150 μm, alternatively less than 100 μm, alternatively less than 50 μm, alternatively less than 25 μm, alternatively less than 10 μm.

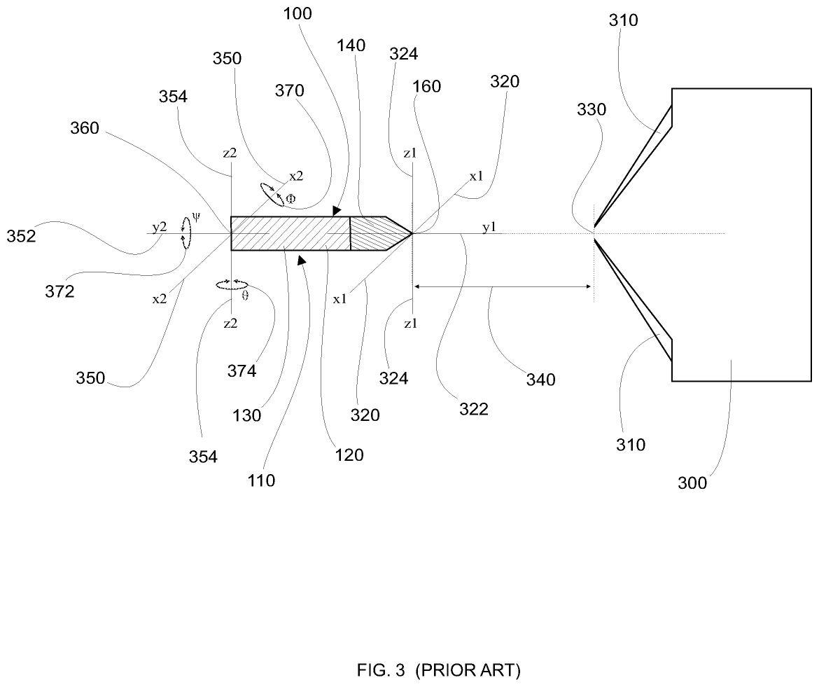

Referring to FIG. 3, the positioning of the Taylor cone emitter device 100 relative to a sample inlet 310 of an analytical instrument 300 is shown. The positioning of the sharp point 160 is represented by a given a set of coordinates named x₁ 320, y₁ 322 and z₁ 324, and relates to the sharp point 160 position with respect to the aperture 330 of the sample inlet 310. The ions travel through the aperture 330 of the sample inlet 310 and are subsequently analyzed. The distance 340 between the sharp point 160 and the aperture 330 of the sample inlet 310 is the shortest path between the elements a Taylor cone ion flux may travel. Another cartesian coordinate, x₂ 350, y₂ 352 and z₂ 354 is described with respect to the emitter distal end 360 and relates to the position of planar surface 130 with respect to the sample inlet 310. The position of planar surface 130 relates to the degree of tilt or level, which is relevant to the ability to effectively receive and retain elution solvent 410 during the Taylor cone production. The rotation of the Taylor cone emitter device 100 is described on each axis in terms of a set of Euler angles ϕ 370, ψ 372, and θ 374. These additional degrees of movement relate to the planal nature of the planar surface 130.

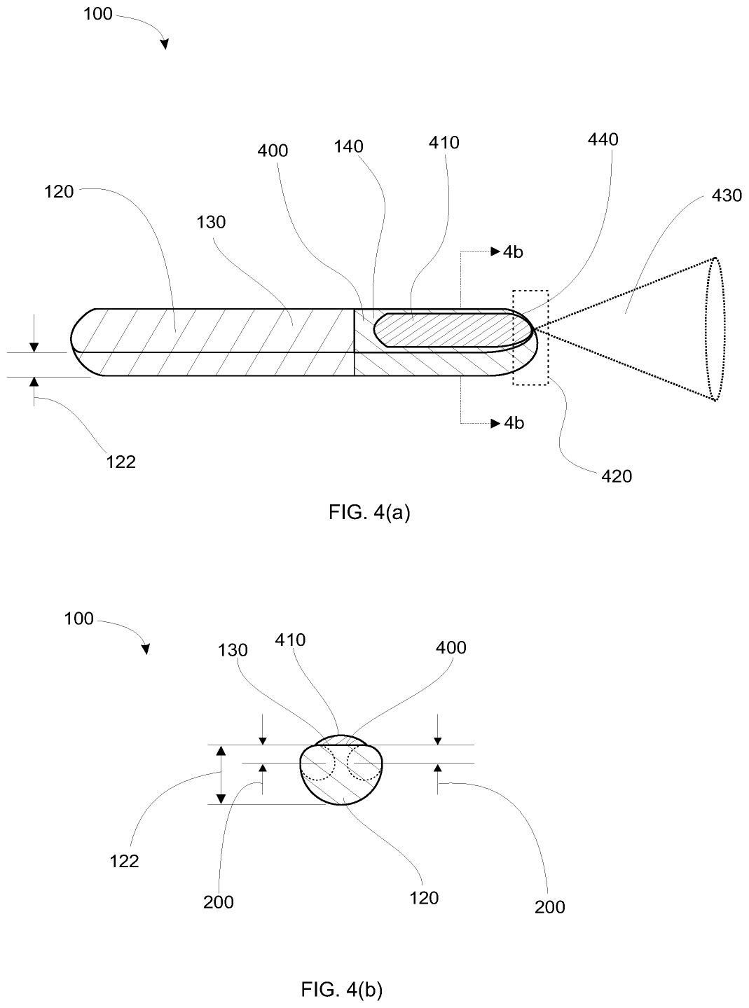

Referring to FIGS. 4(a)-(b), in one embodiment, a Taylor cone emitter device 100 includes a substrate 120, a sorbent layer 140 disposed on at least a portion of the substrate 120, a reservoir surface 400 configured to retain a liquid 410, and a Taylor cone emitter portion 420 extending from the substrate 120. The reservoir surface 400 is configured to feed the liquid 410 to the Taylor cone emitter portion 420 while a Taylor cone 430 is emitted from the Taylor cone emitter portion 420. The Taylor cone emitter portion 420 is free of sharp features having an edge 170 or point 160 with a radius of curvature 200 of less than 250 μm. The Taylor cone emitter portion includes a broadly curved surface 440 having a radius of curvature 200 of at least 300 μm, alternatively at least 350 μm, alternatively at least 400 μm, alternatively at least 450 μm, alternatively at least 500 μm, alternatively at least 600 μm, alternatively at least 700 μm, alternatively at least 800 μm, alternatively at least 900 μm, alternatively at least 1 mm, alternatively at least 1.5 mm, alternatively at least 2 mm, alternatively at least 5 mm, from which the Taylor cone emanates.

The reservoir surface 400 may feed the liquid 410 to the Taylor cone emitter portion 420 by any suitable technique, including, but note limited to, gravity feeding, electroosmotic flow, capillary force, and combinations thereof.

In one embodiment, the broadly curved surface 440 of the Taylor cone emitter portion 420 has a radius of curvature 200 of at least 50% of a thickness 122 of the substrate 120, alternatively at least 55%, alternatively at least 60%, alternatively at least 65%, alternatively at least 70%, alternatively at least 75%, alternatively at least 80%, alternatively at least 85%, alternatively at least 90%, alternatively at least 95%, alternatively at least 100%.

The substrate 120 may be non-porous or porous. In one embodiment, the substrate 120 includes a porous material having open porosity and the reservoir surface 400 is an internal surface of the porous material.

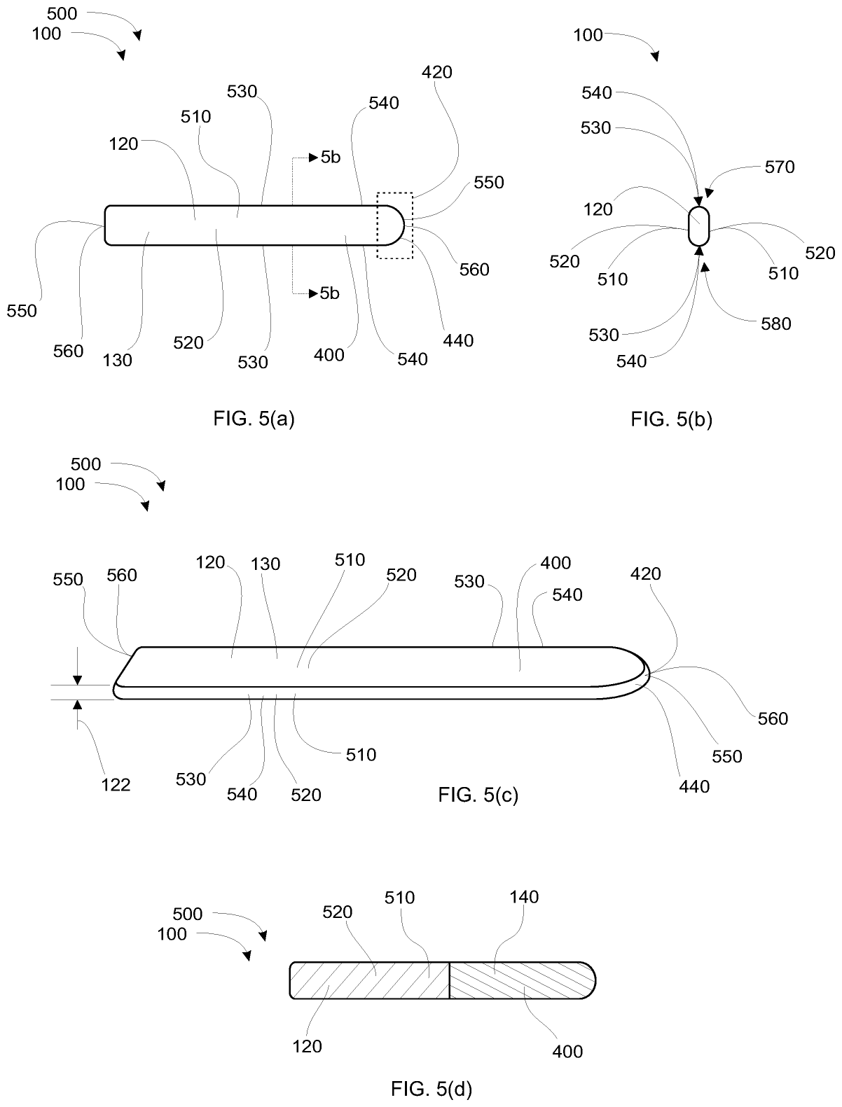

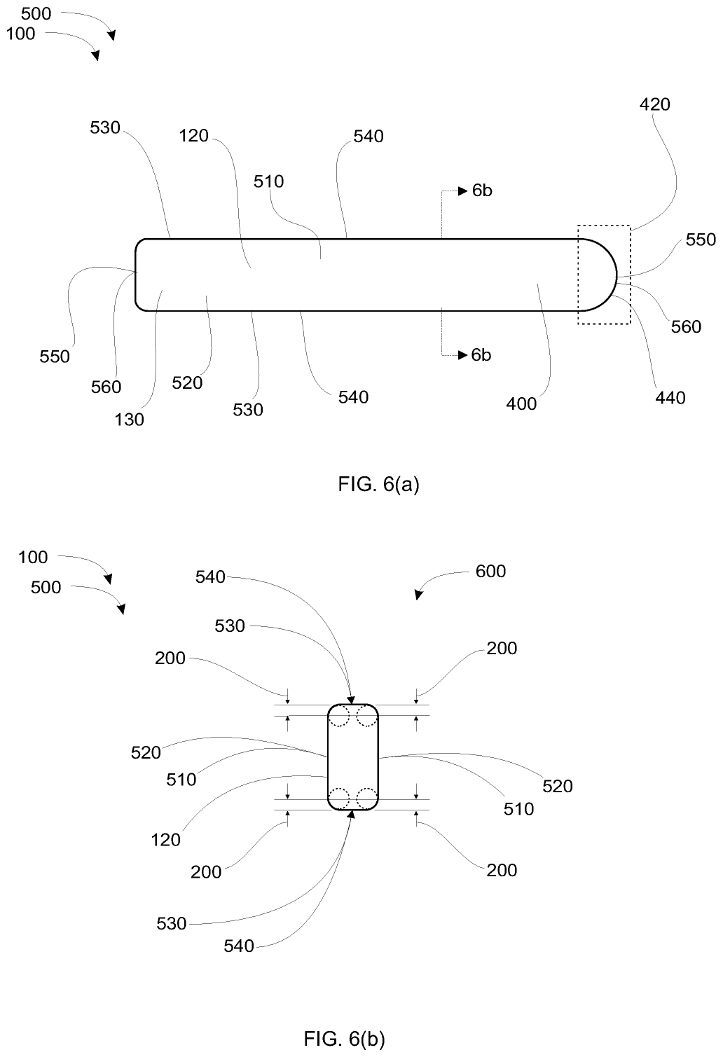

Referring to FIGS. 5(a)-(e) and 6(a)-(b), in one embodiment, the substrate 120 includes a rounded rectangular cuboid portion 500 having a first pair of opposing sides 510 having a first surface area 520, a second pair of opposing sides 530 having a second surface area 540, and a third pair of opposing sides 550 having a third surface area 560. This first surface area 520 is larger than the second surface area 540 and is larger than the third surface area 560. The sorbent layer 140 and the reservoir surface 400 are at least partly disposed on at least one side of the first pair of opposing sides 510 (also or alternatively within if the substrate 120 is a porous material). The Taylor cone emitter portion 420 is one side of the second pair of opposing sides 530 or the third pair of opposing sides 550. The rounded rectangular cuboid portion 500 may have any suitable cross section 570 bisecting the first pair of opposing sides 510, including, but not limited to, a stadium cross section 580 (FIGS. 5(a)-(e)), a rounded rectangular cross section 600 (FIG. 6(a)-(b)), or combinations thereof (as the cross-section 570 is measured in a different plane).

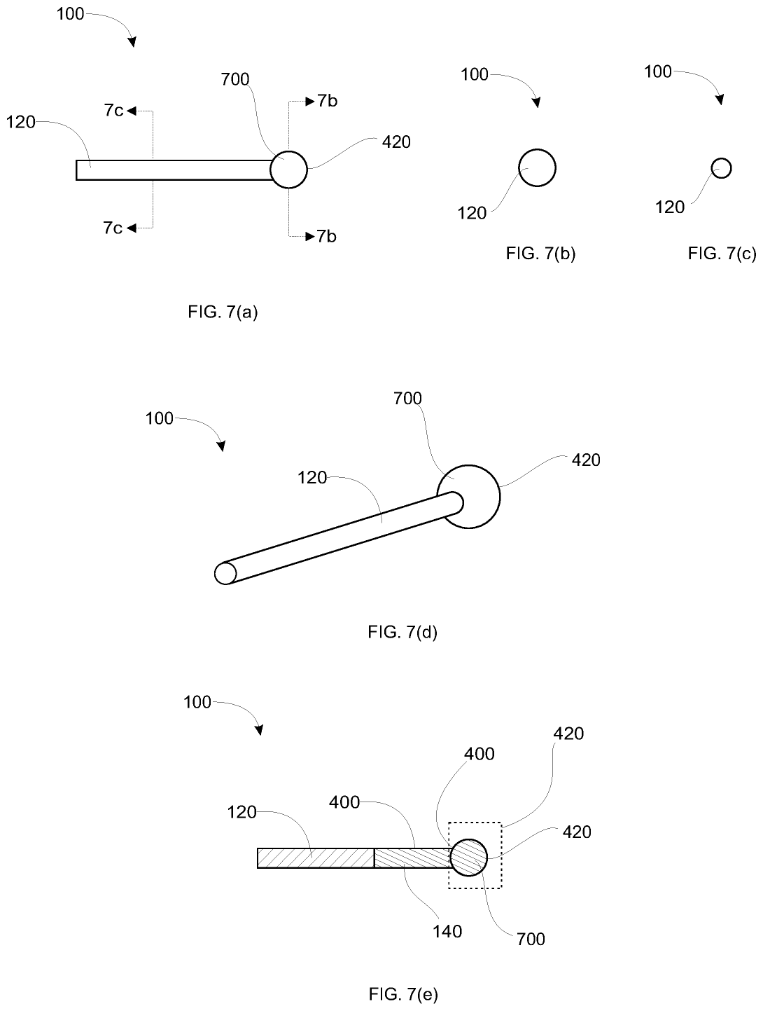

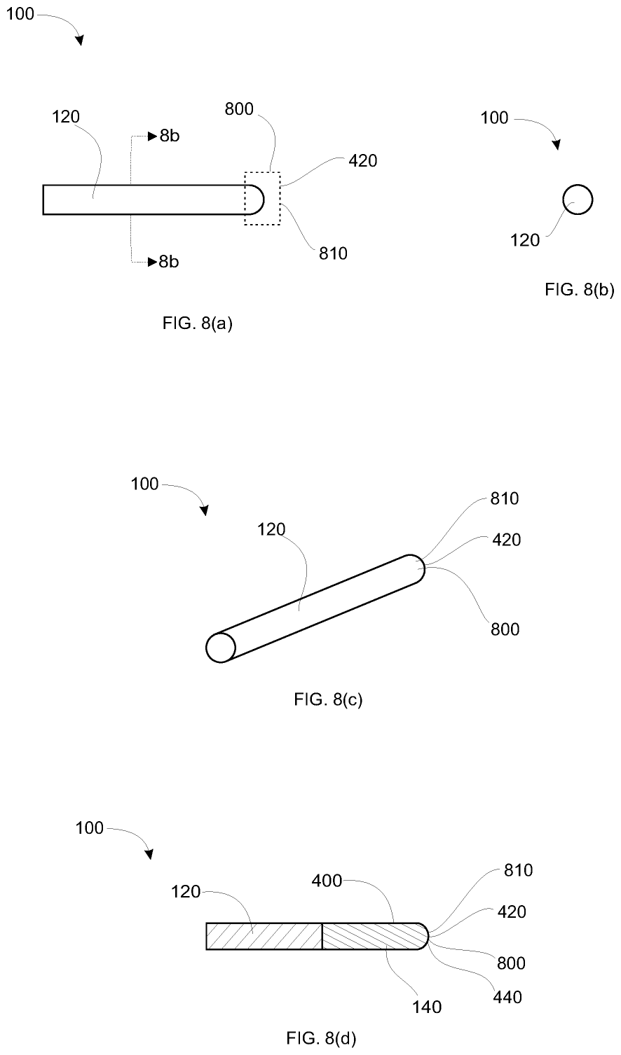

Referring to FIGS. 7(a)-(c) and 8(a)-(d), in one embodiment, the substrate 120 includes a spheroid portion 700 (FIG. 7(a)-(e)) or a frustospheroid portion 800 (FIGS. 8(a)-(d)) as the Taylor cone emitter portion 420, and the sorbent layer 140 and the reservoir surface 400 are at least partly disposed on the spheroid portion 700 or frustrospheroid portion 800 (also or alternatively within if the substrate 120 is a porous material). In a further embodiment of a frustospheroid portion 800, the frustospheroid portion 800 may be a hemispheroid portion 810 as the frustospheroid portion 800.

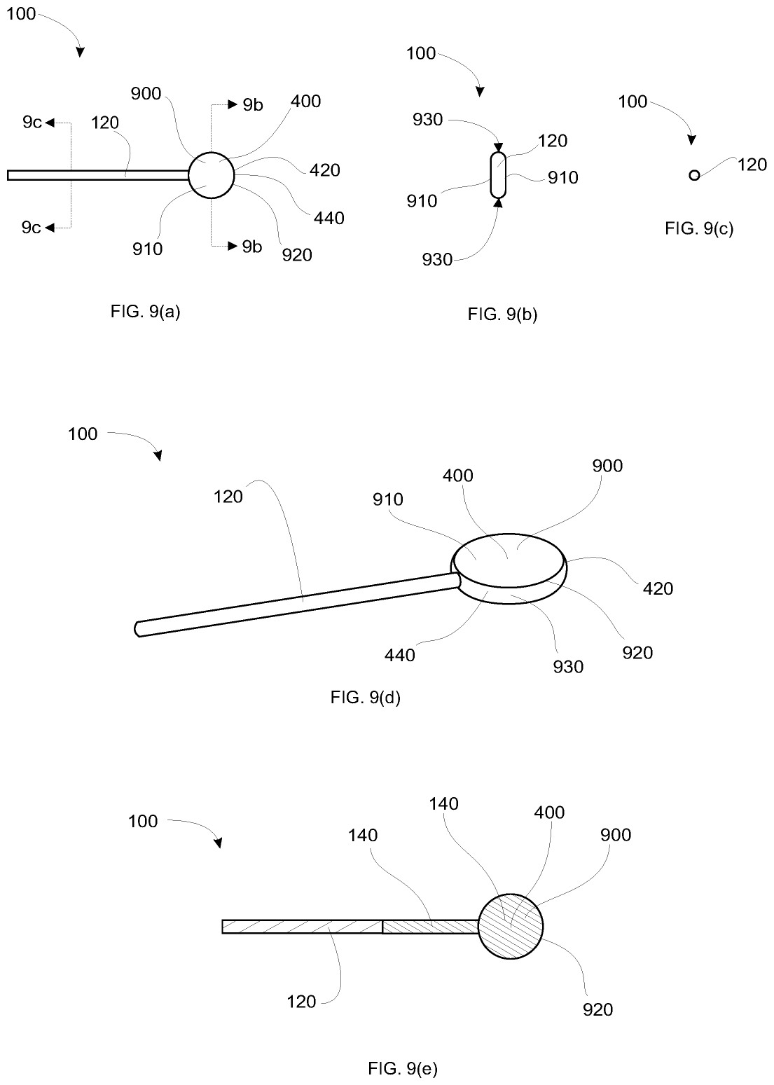

Referring to FIGS. 9(a)-(c), in one embodiment, the substrate includes a rounded discoid portion 900 having a pair of opposing sides 910 having circular (shown), elliptical or oval perimeters 920 and a third side 930 connecting the pair of opposing sides 910. The sorbent layer 140 and the reservoir surface 400 are at least partly disposed on at least one side of the pair of opposing sides 910 (also or alternatively within if the substrate 120 is a porous material). The Taylor cone emitter portion 420 is the third side 930.

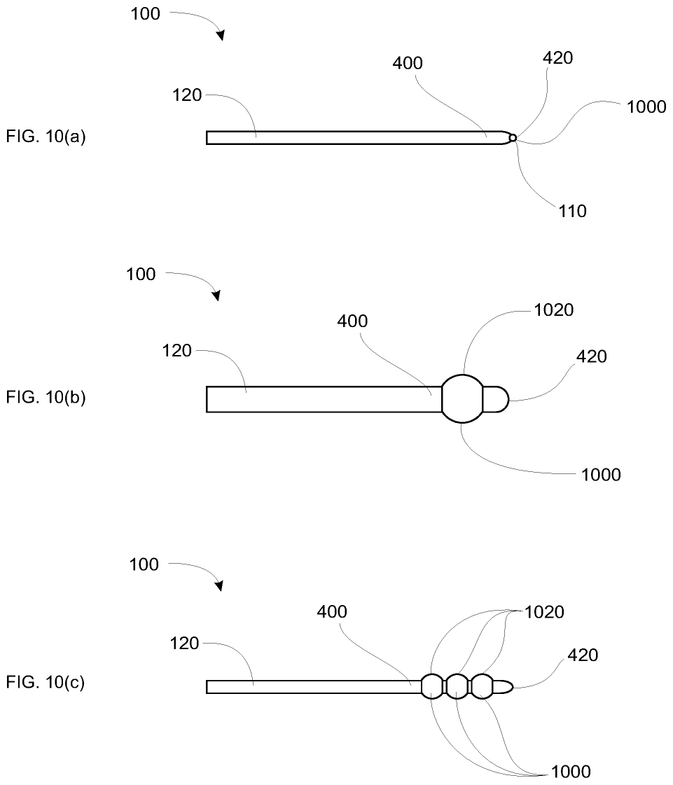

Referring to FIGS. 10(a)-(c), in one embodiment, the reservoir surface 400 includes at least one flow-disrupting surface feature 1000. The flow-disrupting feature may be a terminal flow-disrupting feature 1010 disposed at the Taylor cone emitter portion 420 (FIG. 10(a)) or an intermediate flow disrupting feature 1020 disposed along the substrate 120 prior to the Taylor cone emitter portion 420 (FIG. 10(b)). The at least one flow-disrupting surface feature 1000 may include a plurality of flow-disrupting surface features 1000 (FIG. 10(c)), which may be terminal flow-disrupting features 1010, intermediate flow disrupting features 1020, or combinations thereof.

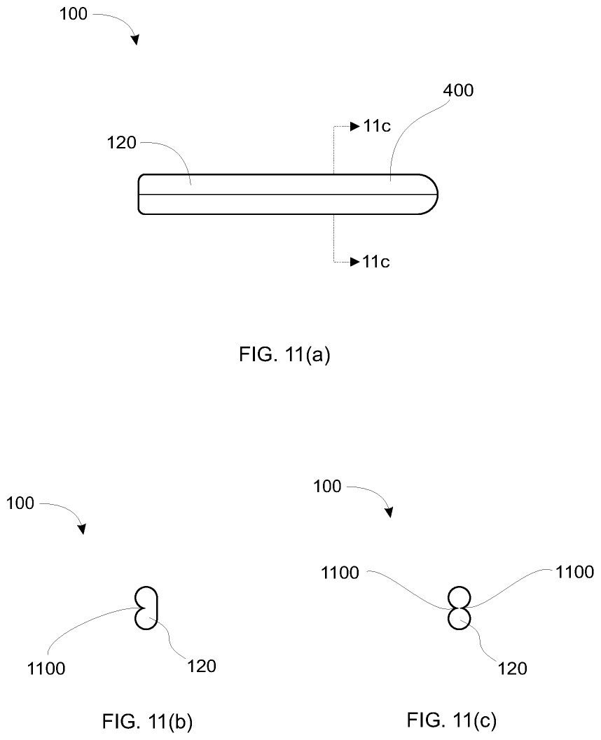

Referring to FIGS. 11(a)-(c), in one embodiment, the reservoir surface 400 includes at least one liquid-channeling groove 1100. The at least one liquid-channeling groove 1100 may include one liquid-channeling groove 1100 (FIG. 11(b)), two liquid-channeling grooves 1100 (FIG. 11(c)), or more.

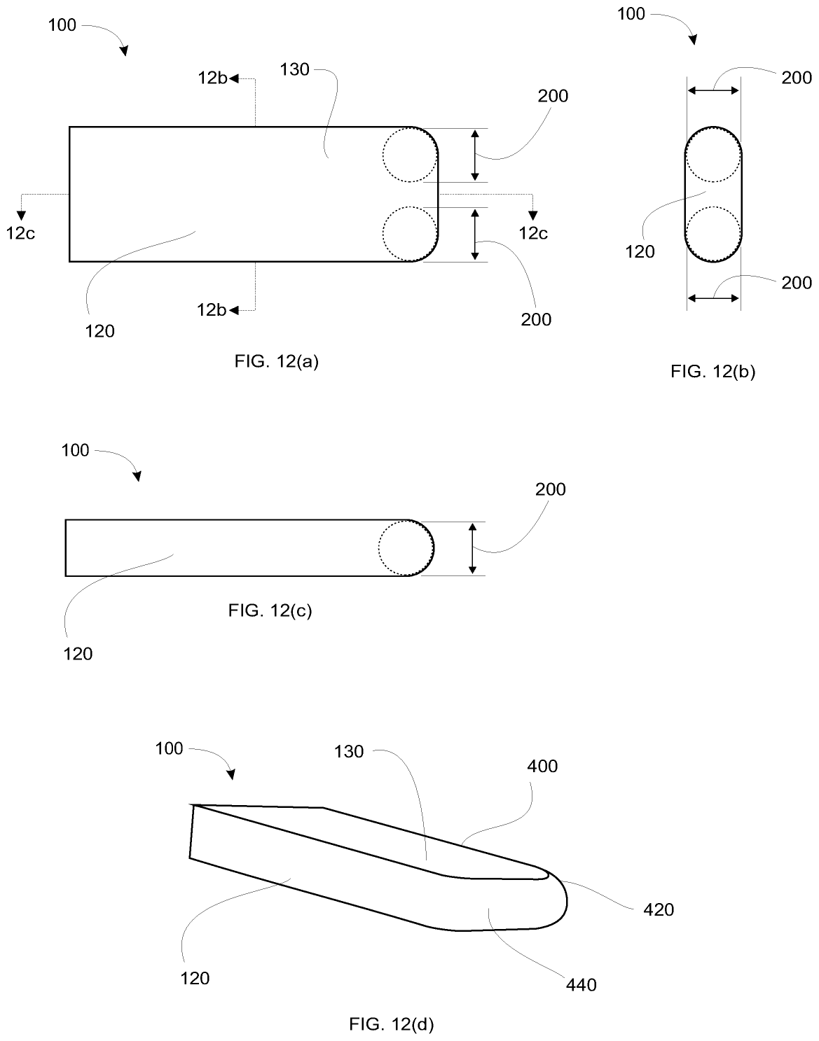

Referring to FIGS. 4(a), 5(c), 7(d), 9(d), and 12(a)-(d), the broadly curved surface may be curved in two dimensions (FIG. 12(a)-(d)) or three dimensions (FIGS. 4(a), 5(c), 7(d), and 9(d)).

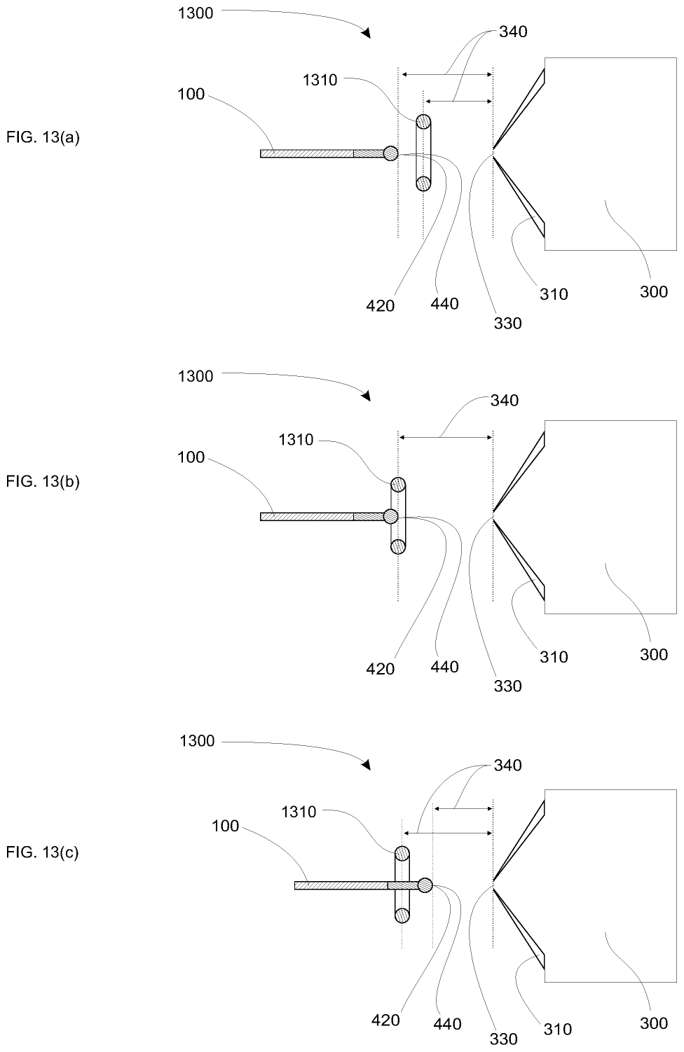

Referring to FIGS. 13(a)-(c), in one embodiment a Taylor cone analysis system 1300 includes an analytical instrument 300 having a sample inlet 310, at least one electric field lens 1310, and a Taylor cone emitter device 100 with a Taylor cone emitter portion 420 free of sharp features having an edge 170 or point 160 with a radius of curvature 200 of less than 250 μm. The Taylor cone emitter portion 420 includes a broadly curved surface 440 having a radius of curvature 200 of at least 300 μm from which the Taylor cone 430 emanates. The at least one electric field lens 1310 is configured to tune Taylor cone generation from the Taylor cone emitter portion 420.

The at least one electric field lens 1310 may include a lens 1310 disposed between the Taylor cone emitter portion 420 and the sample inlet 310 during Taylor cone generation, with the lens 1310 being configured to aim the Taylor cone 430 generated from the Taylor cone emitter portion 420 toward the sample inlet 310 (FIG. 13(a)), the at least one electric field lens 1310 may include a lens 1310 disposed at an equal distance 340 from the sample inlet 310 as the Taylor cone emitter portion 420 is disposed during Taylor cone generation (FIG. 13(b)) or at a greater distance 340 from the sample inlet 310 as the Taylor cone emitter portion 420 is disposed such that the Taylor cone emitter portion 420 is between the lens 1310 and the sample inlet 310 during Taylor cone generation (FIG. 13(c)) with the lens 1310 being configured to suppress secondary Taylor cone formation, arcing, corona discharge, or combinations thereof, or a combination of such embodiments.

The at least one electric field lens 1310 may have any suitable shape, including, but not limited to, a toroidal or annular lens shape.

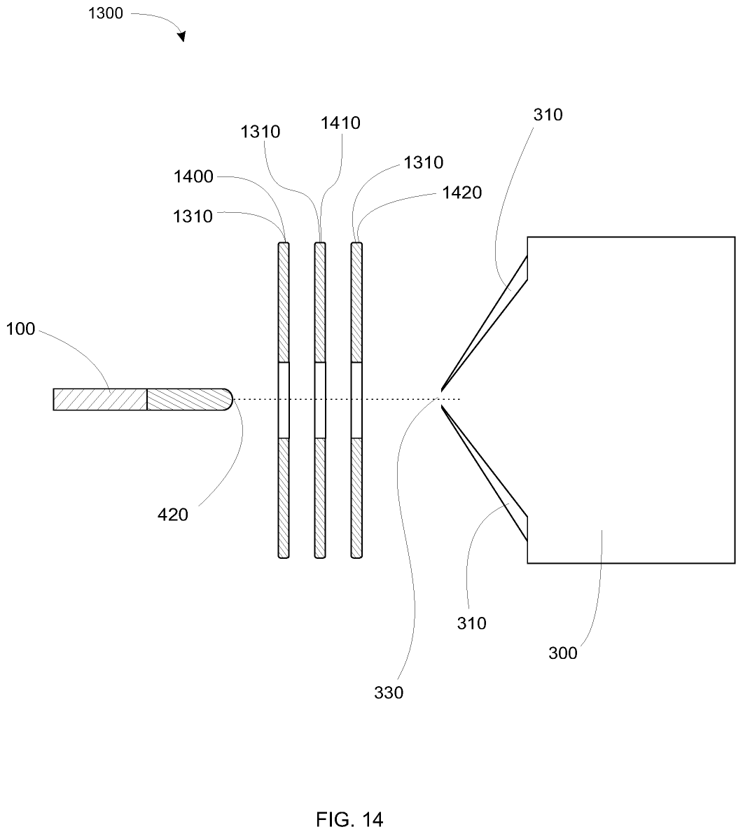

Referring to FIG. 14. In one embodiment, the at least one electric field lens 1310 includes a first lens 1400, a second lens 1410, and a third lens 1420. Each of the at least one electric field lenses 1310 may have the same or a different voltage potential.

Referring to FIGS. 13(a)-(c) and 14, the at least one electric field lens 1310 may enhance or focus the electric field density on the Taylor cone emitter portion 420 where the Taylor cone 430 is desired. The voltage applied to the at least one electric field lens 1310 may be less than the emitter voltage for the Taylor cone emitter device 100. At least one electric field lens 1310 elements at the same voltage or within about 75% of the emitter voltage may form a larger uniform electric field. At least one electric field lens 1310 elements in line with or behind the Taylor cone emitter portion 420 may promote a uniform field at every location of the emitter except the Taylor cone emitter portion 420. This may reduce or eliminate the risk of arcing or corona discharge in general, as the voltage potential drop from the field location to the open air is now remote from the Taylor cone emitter portion 420.

In one embodiment, when used as a component of the Taylor cone analysis system 1300, the Taylor cone emitter device 100 produces a stable Taylor cone 430 with a voltage of less than 5 kV being applied to the Taylor cone emitter device 100, alternatively less than 4.5 kV, alternatively less than 4 kV, alternatively less than 3.5 kV, alternatively less than 3 kV.

In one embodiment, when used as a component of the Taylor cone analysis system 1300, the Taylor cone emitter device 100 produces a stable Taylor cone 430 suitable for reproducibly delivering analyte to the sample inlet 310 at a distance 340 of at least 3 mm, alternatively at least 4 mm, alternatively at least 5 mm, alternatively at least 6 mm, alternatively at least 7 mm, alternatively at least 8 mm, alternatively at least 9 mm, alternatively at least 10 mm, alternatively at least 11 mm, alternatively at least 12 mm, alternatively at least 13 mm, alternatively at least 14 mm, alternatively at least 15 mm, alternatively between 3 mm and 15 mm, alternatively at between 3 mm and 7 mm, alternatively at between 5 mm and 9 mm, alternatively at between 7 mm and 11 mm, alternatively at between 9 mm and 13 mm, alternatively at between 11 mm and 15 mm, or combinations or sub-ranges thereof.

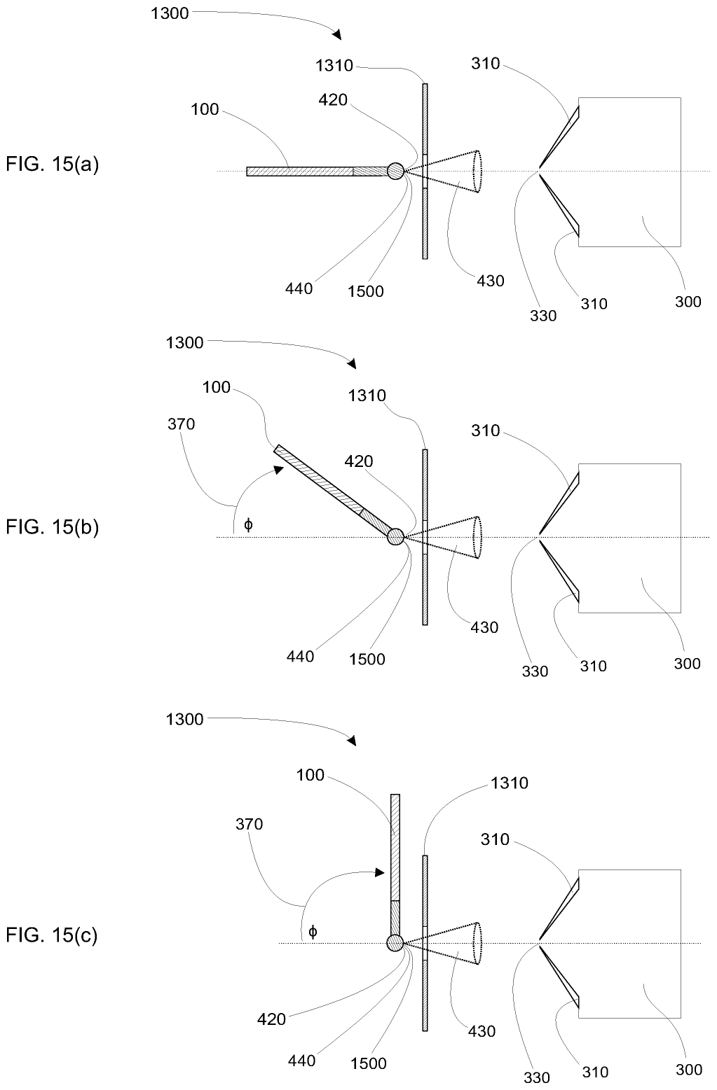

Referring to FIGS. 15(a)-(c), in one embodiment, the electrical surface charge is evenly distributed along the broadly curved surface 440. A specific region 1500 of the broadly curved surface 440 from which the Taylor cone 430 emanates may be determined by a relative orientation of the broadly curved surface 440 to an electrical-field coupled sample inlet 310. As such, the Taylor cone emitter device 100 may be oriented relative to the sample inlet 310 in any suitable orientation, including, but not limited to, a normal angle (FIG. 15(a)), an oblique angle (FIG. 15(b)), or a perpendicular angle (FIG. 15(c)). Furthermore, although FIGS. 15(a)-(c) show rotation of the Taylor cone emitter device 100 about the Euler angle ϕ 370 (as shown in FIG. 3), the Taylor cone emitter device 100 may also be rotated about Euler angles ψ 372 or θ 374. Further, the Taylor cone emitter device 100 may be rotated about any combination of Euler angles ϕ 370, ψ 372, and θ 374 so as to alter the specific region 1500 of the broadly curved surface 440 from which the Taylor cone 430 emanates.

### Examples

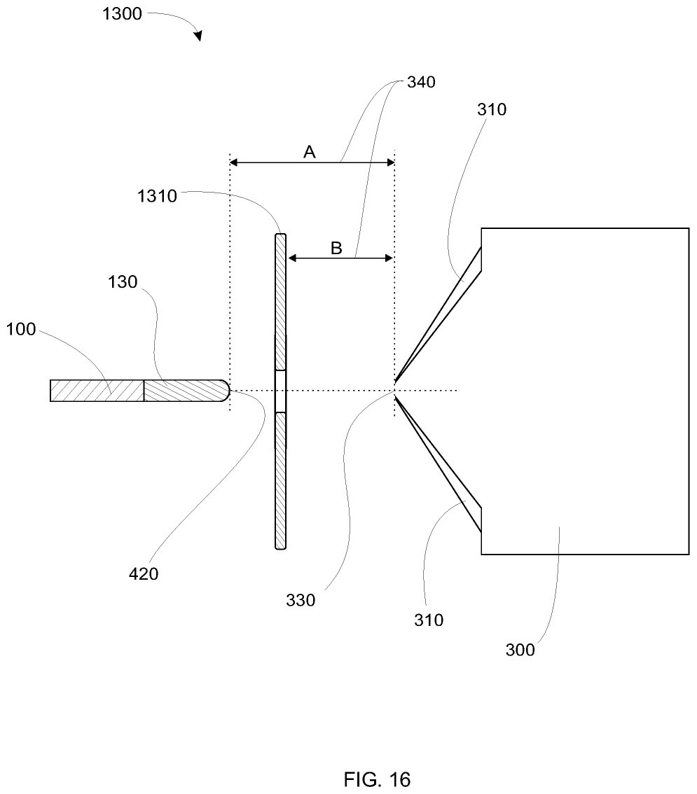

A laboratory-built Taylor cone analysis system 1300 was assembled as shown in FIG. 16 having a Taylor cone emitter device 100, an electric field lens 1310, and a sample inlet 310 representing an analytical instrument 300. The sample inlet 310 was a 4″ diameter conical stainless steel skimmer cone plate (SCIEX; p/n 5046330) suitable for a SCIEX Triple Quad™ 4500 System mass spectrometer connected to Earth ground. The following experimental results presented here are specific to the Taylor cone generated under the influence of an electric field. The Taylor cone emitter device 100 was secured in a fixture having pliers-like jaws configured to hold the Taylor cone emitter device 100 in a horizontal orientation and in connection with a Matsusada HV power supply (Matsusada, ES series, R type). The Taylor cone analysis system 1300 further included an insulated fixture for positioning the electric field lens 1310 with the electric field lens 1310 being in electrical communication with a lens HV power supply (BKPrecision, model 1550). The electric field lens 1310 was a standard stainless steel circular washer (1.5 inch outer diameter, 7/16 inch aperture diameter, 0.050″ thick). An electrical wire was attached to the electric field lens 1310 to connect to the BKPrecision power supply. The fixture for the electric field lens 1310 and the fixture for the Taylor cone emitter device 100 were positioned to align the Taylor cone emitter portion 420 of the taylor cone emitter device 100, the center of the aperture of the electric field lens 1310, and the opening of the sample inlet 310. A webcam with macro focus and magnification capability was used to observe the Taylor cone 430 formed from the Taylor cone emitter portion 420.

Elution solvent 410 was prepared using a 95%/5% wt/wt methanol/water solution. Three Taylor cone emitter device 100 designs were tested: (1) a commercial CBS device 110 obtained from Restek (Catalog No. 23248), similar to FIG. 1; (2) a commercial CBS device 110 obtained from Restek similar to FIG. 1, with its sharp point 160 sanded off so as to leave a fully rounded Taylor cone emitter portion 420 with a radius of curvature 200 one-half the width of the CBS device 110 and one-half the blade thickness 122; and (3) a Taylor cone emitter device 100 as shown in FIGS. 5(a)-(d). The Taylor cone emitter device 100 was fabricated using a 0.699 inch long gold coated PC Pin Terminal Connector (Mill-Max Manufacturing Corp., p/n 4395-0-00-15-00-00-08-0). The pin was placed in a precision vise and compressed to produce two planar surfaces 130 about 1.5 mm wide along the axial length of the pin. This post processing maintained curved edges along the entire perimeter of the planar surfaces 130, and maintained a curved Taylor cone emitter portion 420.

After loading the Taylor cone emitter device 100 into the Taylor cone analysis system 1300 and positioning the electric field lens 1310, 7.5 μL of elution solvent 410 was applied to the reservoir surface 400 and the voltage was applied to the Taylor cone emitter device 100. The voltage was increased on the Taylor cone emitter device 100 until a Taylor cone 430 was observed. It was found that the Taylor cone 430 was maintained when the voltage was slightly reduced. The minimum voltage required to maintain the Taylor cone 430 was recorded.

All distances measured with respect to the Taylor cone emitter device 100 and the electric field lens 1310 positions were indexed from the aperture 330 of the sample inlet 310. In the tables below, “A:” is the distance between the Taylor Cone Emitter Portion 420 and the aperture 330, and “B” is the distance between the electric field lens 1310 and the aperture 330. With respect to the three elements of the setup, three relative positions were evaluated. When B=A the Taylor Cone Emitter Portion 420 is at the entrance of the aperture of the electric field lens 1310. When A>B, the electric field lens 1310 is between the Taylor Cone Emitter Portion 420 and the aperture 330. When A<B, the Taylor Cone Emitter Portion 420 is between the electric field lens 1310 aperture and the aperture 330. In all cases the aperture 330 was held at Earth ground. Taylor cone voltages were recorded for setups having no electric field lens 1310 present (i.e., the Taylor Cone Emitter Portion 420 and the aperture 330 only), as well as several combinations of electric field lenses 1310 and Taylor Cone Emitter Portion 420. Triplicate runs of each configuration were performed.

TABLE 1
Commercial CBS device 110.
lens voltage = ground = skimmer cone
AVERAGE VALUES; n = 3

| | | | |
|---|---|---|---|
| B/A | 5 mm | 7.5 mm | 10 mm |

| | | | | | | |
|---|---|---|---|---|---|---|
| — | 2.58 | kV | 2.9 | kV | 3.15 | kV |

| | | | | | | | |
|---|---|---|---|---|---|---|---|
| 2.5 | mm | 2 | kV | 2.57 | kV | 2.52 | kV |
| 5 | mm | 2.02 | kV | 2.25 | kV | 2.32 | kV |
| 7.5 | mm | 2.02 | kV | 2.25 | kV | 2.52 | kV |
| 10 | mm | 2.23 | kV | 2.25 | kV | 2.27 | kV |

| | | | | | | |
|---|---|---|---|---|---|---|
| 12.5 | mm | . . . | 2.22 | kV | 2.1 | kV |

| | | | | | |
|---|---|---|---|---|---|
| 15 | mm | . . . | . . . | 2.3 | kV |

TABLE 2
Modified CBS Device 110 with rounded Taylor cone emitter portion 420.
lens voltage = ground = skimmer cone
AVERAGE VALUES; n = 3

| | | | |
|---|---|---|---|
| B/A | 5 mm | 7.5 mm | 10 mm |

| | | | | | | |
|---|---|---|---|---|---|---|
| — | 3.68 | kV | 4.03 | kV | 4.27 | kV |

| | | | | | | | |
|---|---|---|---|---|---|---|---|
| 2.5 | mm | 3.17 | kV | 3.78 | kV | 4 | kV |
| 5 | mm | 3.1 | kV | 3.03 | kV | 3.87 | kV |
| 7.5 | mm | 3.03 | kV | 3.1 | kV | 3.58 | kV |
| 10 | mm | 3.02 | kV | 3.07 | kV | 3.1 | kV |

| | | | | | | |
|---|---|---|---|---|---|---|
| 12.5 | mm | . . . | 3.13 | kV | 3.05 | kV |

| | | | | | |
|---|---|---|---|---|---|
| 15 | mm | . . . | . . . | 3.12 | kV |

TABLE 3
Taylor cone emitter device 100 as shown in FIGS. 5(a)-(d).
lens voltage = ground = skimmer cone
AVERAGE VALUES; n = 3

| B/A | 5 mm | 7.5 mm | 10 mm |
|---|---|---|---|
| — | 4.03 kV | 4.48 kV | 4.72 kV |

| | | | | |
|---|---|---|---|---|
| 2.5 | mm | 3.55 kV | 3.92 kV | 4.55 kV |
| 5 | mm | 3.35 kV | 3.63 kV | 4.32 kV |
| 7.5 | mm | 3.45 kV | 3.52 kV | 4.27 kV |
| 10 | mm | 3.48 kV | 3.42 kV | 3.97 kV |
| 12.5 | mm | . . . | 3.62 kV | 3.58 kV |
| 15 | mm | . . . | . . . | 3.65 kV |

In all setup cases, the minimum voltage required to create a stable Taylor cone 430 was less than 5 kV. Inexpensive board mount power supplies which are commercially available are available for output values up to 5 kV. Taylor Cone Emitter Devices 100 free of sharp features having an edge 170 or point 160 with a radius of curvature 200 of less than 250 μm produced stable Taylor cones 430, with reproducible location on the Taylor cone emitter portion 420. In all cases the presence of the electric field lens 1310 held at ground reduced the minimum voltage required to create a stable Taylor cone 430.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A Taylor cone emitter device, comprising:
a substrate;
a sorbent layer disposed on at least a portion of the substrate;
a reservoir surface configured to retain a liquid; and
a Taylor cone emitter portion extending from the substrate,
wherein:
the reservoir surface is configured to feed the liquid to the Taylor cone emitter portion while a Taylor cone is emitted from the Taylor cone emitter portion;
the Taylor cone emitter portion is free of sharp features having an edge or point with a radius of curvature of less than 250 μm; and
the Taylor cone emitter portion includes a broadly curved surface having a radius of curvature of at least 300 μm from which the Taylor cone emanates.

2. The Taylor cone emitter device of claim 1, wherein the broadly curved surface of the Taylor cone emitter portion has a radius of curvature of at least 50% of a thickness of the substrate.

3. The Taylor cone emitter device of claim 1, wherein the reservoir surface includes at least one flow-disrupting surface feature.

4. The Taylor cone emitter device of claim 1, wherein the reservoir surface includes at least one liquid-channeling groove.

5. The Taylor cone emitter device of claim 1, wherein the broadly curved surface is curved in two dimensions.

6. The Taylor cone emitter device of claim 1, wherein the broadly curved surface is curved in three dimensions.

7. The Taylor cone emitter device of claim 1, wherein an electrical surface charge is evenly distributed along the broadly curved surface.

8. The Taylor cone emitter device of claim 1, wherein a specific region of the broadly curved surface from which the Taylor cone emanates is determined by a relative orientation of the broadly curved surface to an electrical-field coupled sample inlet.

9. The Taylor cone emitter device of claim 1, wherein the substrate includes a rounded rectangular cuboid portion having:
a first pair of opposing sides having a first surface area;
a second pair of opposing sides having a second surface area; and
a third pair of opposing sides having a third surface area,
wherein:
the first surface area is larger than the second surface area and is larger than the third surface area;
the sorbent layer and the reservoir surface are at least partly disposed on at least one side of the first pair of opposing sides; and
the Taylor cone emitter portion is one side of the second pair of opposing sides or the third pair of opposing sides.

10. The Taylor cone emitter device of claim 9, wherein the rounded rectangular cuboid portion has a stadium cross section bisecting the first pair of opposing sides.

11. The Taylor cone emitter device of claim 9, wherein the rounded rectangular cuboid portion has a rounded rectangular cross section bisecting the first pair of opposing sides.

12. The Taylor cone emitter device of claim 1, wherein the substrate includes a spheroid portion or frustrospheroid portion as the Taylor cone emitter portion and the sorbent layer and the reservoir surface are at least partly disposed on the spheroid portion or the frustrospheroid portion.

13. The Taylor cone emitter device of claim 12, wherein the substrate includes a hemispheroid portion as the frustospheroid portion.

14. The Taylor cone emitter device of claim 1, wherein the substrate includes a rounded discoid portion having:
a pair of opposing sides having circular, elliptical or oval perimeters; and
a third side connecting the pair of opposing sides; and
wherein:
the sorbent layer and the reservoir surface are at least partly disposed on at least one side of the pair of opposing sides; and
the Taylor cone emitter portion is the third side.

15. A Taylor cone analysis system, comprising:
an analytical instrument having a sample inlet;
at least one electric field lens; and
a Taylor cone emitter device including:
a substrate;
a sorbent layer disposed on at least a portion of the substrate;
a reservoir surface configured to retain a liquid; and
a Taylor cone emitter portion extending from the substrate,
wherein:
the reservoir surface is configured to feed the liquid to the Taylor cone emitter portion while a Taylor cone is emitted from the Taylor cone emitter portion;
the Taylor cone emitter portion is free of sharp features having an edge or point with a radius of curvature of less than 250 μm;
the Taylor cone emitter portion includes a broadly curved surface having a radius of curvature of at least 300 μm from which the Taylor cone emanates; and
the at least one electric field lens is configured to tune Taylor cone generation from the Taylor cone emitter portion.

16. The Taylor cone analysis system of claim 15, wherein the at least one electric field lens includes a lens disposed between the Taylor cone emitter portion and the sample inlet during Taylor cone generation, the lens being configured to aim a Taylor cone generated from the Taylor cone emitter portion toward the sample inlet.

17. The Taylor cone analysis system of claim 15, wherein the at least one electric field lens includes a lens disposed at an equal distance from the sample inlet as the Taylor cone emitter portion is disposed during Taylor cone generation or at a greater distance from the sample inlet as the Taylor cone emitter portion is disposed such that the Taylor cone emitter portion is between the lens and the sample inlet during Taylor cone generation, the lens being configured to suppress secondary Taylor cone formation, arcing, corona discharge, or combinations thereof.

18. The Taylor cone analysis system of claim 15, wherein the at least one electric field lens has a toroidal or annular lens shape.

19. The Taylor cone analysis system of claim 15, wherein the at least one electric field lens includes a first lens, a second lens, and a third lens, each having a different voltage potential.

20. The Taylor cone analysis system of claim 15, wherein the Taylor cone emitter device produces a stable Taylor cone with a voltage of less than 5 kV being applied to the Taylor cone emitter device.
